(19) United States
(12) Patent Application Publication
(10) Pub. No.: US 2012/0006132 A1
(43) Pub. Date: Jan. 12, 2012

(54) PROBE HOLDER ADJUSTABLE TO CONFORM TO TEST SURFACES

(76) Inventors: Denis Faucher, Quebec (CA); Jason Habermehl, Quebec (CA)

(21) Appl. No.: 12/833,539

(22) Filed: Jul. 9, 2010

(51) Int. Cl. G01D 21/00

(52) U.S. Cl. 73/866.5

(57) ABSTRACT

Disclosed is an acoustic probe/wedge holder that facilitates the operation of holding and sliding the probe over often non-flat test surfaces. The probe/wedge holder is configured to allow the adjustment of the probe/wedge so that the footing of the probe holder and the test surface of the probe or wedge collectively match the surface of a test object, allowing the probe or wedge to have intimate contact with the test surface and the probe holder to be stably disposed on or gliding over the surface of the test object. The surface of the test object is often of non-flat surface, such as that of a pipe.

### FIELD OF THE INVENTION

This invention relates to non-destructive testing and inspection (NDT/NDI) and more particularly to an NDT/NDI probe holder that facilitates the adjustment of the probe or a delay-line and probe to conveniently match the surface of test objects, such as pipes.

### BACKGROUND OF THE INVENTION

Many NDT/NDI applications involve inspection of target objects with un-even test surfaces, such as oil pipes, gas tanks, etc. Many NDT/NDI inspection probes require to be consistently coupled with the test surfaces at a correct angle, while the probes are slid over the test surfaces. For example, ultrasonic transducers need to be coupled to pipes being inspect at a correct angle for excitation and detection of various wave modes used for flaw detection. Coupling of the transducers is complicated by the curvature of the pipe or other test object under inspection. Another example is that eddy current sensors require constant lift-off from the inspected surface, which presents certain challenges when the sensors are slid over an un-even surface.

In some existing efforts, such as in ultrasound detection, solid Rexolite® or plastic wedges (or shoes) are used to couple the ultrasound into the pipe. When using plastic shoes, the shoes are machined so that the transducers are positioned at a correct angle to the pipe surface to create the wave mode as desired, while the contact area of the shoes is machined to fit the curvature of the pipe. While this approach works, it requires manufacturing a large number of shoes to cover the various diameters of pipes and other containers in use, since each pipe or other types of containers require a different radius shoe. This causes evident problems for service companies due to wedge delivery lead times and maintaining a large stock of custom wedges.

Furthermore, the user either needs transducers for each set of wedges, or has to move the transducers to a new set of wedges if a different pipe size is to be inspected. This is time consuming, and can result in damaged wedges and transducers due to the large amount of handling involved.

The present invention overcomes the problems of the prior art by providing a robust and conveniently adjustable probe holder that facilitates the coupling between probes and testing target surface, such that of pipes and other containers. The advantages that the present invention would become obvious with the disclosure as follows.

### SUMMARY OF THE INVENTION

As noted, the present invention provides a convenient and robust probe holder with the height of the probe easily adjustable to fit for the coupling with test objects with non-flat surfaces, such as pipes and tubes, etc. The probe holder readily and easily situates the probe with adequate coupling and stable contact with various diameters of pipe or other test objects without the need to replace the wedge and probe. Coupling can be a variety of means, commonly known as wedges of solid plastic, rubber or water, etc. These wedges can be separate from the probe or integrated therein. This design eliminates the need for a new set of custom curved wedges for each pipe diameter. The compact size allows the probe to be used in confined areas encountered in inspections.

It should be noted that in the present disclosure, “wedge” and “delay-line” are used interchangeably. Furthermore, “sensor”, “transducer” and “probe” are used interchangeably.

Accordingly, it is a general object of the present disclosure to provide a probe holder, which can readily and easily situate probes with adequate and stable coupling with various diameters of test surfaces, such as those of pipes, tanks, plates, pressure vessels, etc., without the need to replace the wedge and/or probes.

It is further an object of the present disclosure to provide an acoustic probe/wedge holder that facilitates the operation of holding and sliding the probe over often non-flat test surfaces. The probe/wedge holder is configured to allow the adjustment of the probe/wedge so that the footing of the probe holder and the test surface of the wedge collectively match the surface of a test object, such as a pipe, allowing the wedge/probe and the probe holder to be stably and snugly disposed on or glide over the surface of the test object.

It is further an object of the present disclosure to employ a variety of delay line materials such as hard plastic (Rexolite®), rubber and water columns to be used with the herein disclosed probe/wedge holder.

It is further an object of the present disclosure to provide 0° adjustable wedges to be used with the herein disclosed probe/wedge holder.

It is further an object of the present disclosure to provide adjustable wedges for angle beam inspections to be used with the herein disclosed probe/wedge holder.

It is further an object of the present disclosure to provide an adjustable dual pitch-catch phased array probe to be used with the herein disclosed probe/wedge holder.

It should be further understood that the presently disclosed probe holder provides the advantages of simple-to-operate and improved coupling with a large range of test object surface curvatures due to the capability of adjusting the relative position of delay-lines and test surfaces.

### BRIEF DESCRIPTION OF THE DRAWINGS

FIG. 1 is a schematic diagram showing the probe holder according to the present invention holding a phased array probe with the 0° solid plastic wedge.

FIG. 2 is a top view showing the probe holder according to the present invention holding a phased array probe with an adjustable 0° solid plastic wedge.

FIG. 3 is a schematic diagram showing the probe holder according to the present invention holding a phased array probe with an angle beam solid plastic wedge.

FIG. 4 is a schematic diagram showing the probe holder according to the present invention holding a dual phased array probe.

FIG. 5 is a schematic diagram showing an alternative embodiment of the probe holder according to the present invention holding PA probe with 0° water wedge. Also shown is the wheeling footing arrangement in this embodiment.

### DETAILED DESCRIPTION OF THE INVENTION

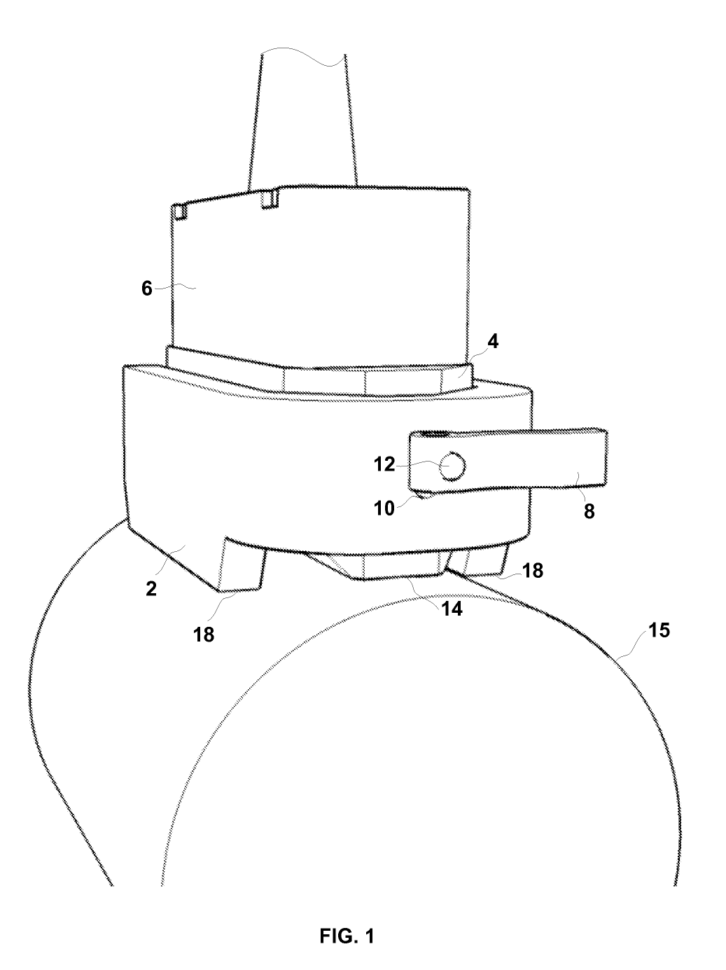

Referring to FIG. 1, a preferred embodiment of a presently disclosed NDT/NDI probe holder 2 is described. As can be seen, probe holder 2 is configured to hold a 0° solid plastic delay-line 4 and a phased array probe 6. Holder 2 further includes a vertical slot 10 and a wear footing 18. Probe 6 is affixed to delay-line 4. Delay-line 4 is made of typical ultrasonic wedge material such as Rexolite®. Delay-line 4, being attached to a rod 12, is vertically slidable within slot 10.

Also can be seen in FIG. 1, rod 12 is attached to a two-position latch 8. When latch 8 is at an open position, the respective positions of wear footing 18 and coupling surface 14 are vertically freely adjustable, thereby allowing for locating a relative position so that coupling surface 14 is in intimate contact with test object 15. Once such fitting is established, latch 8 is then switched to a locked position, at which coupling surface 14 maintains an intimate acoustic coupling to the test object 15 to facilitate the ultrasonic inspection while wear footing 18 provides appropriate stability of holder 2. As can be seen, the novel design allows delay-line 4 and holder wear footing 18 to fit naturally and snugly onto surface 15. The probe holder is hence ready to be glided over the surface of the test objects, with the delay-line having a snug fit with the surface of the test object.

Readjusting probe holder for inspecting a different test object with a changed diameter is as easy as unlatching latch 8, situating probe holder 2 onto test surface and locking latch 8.

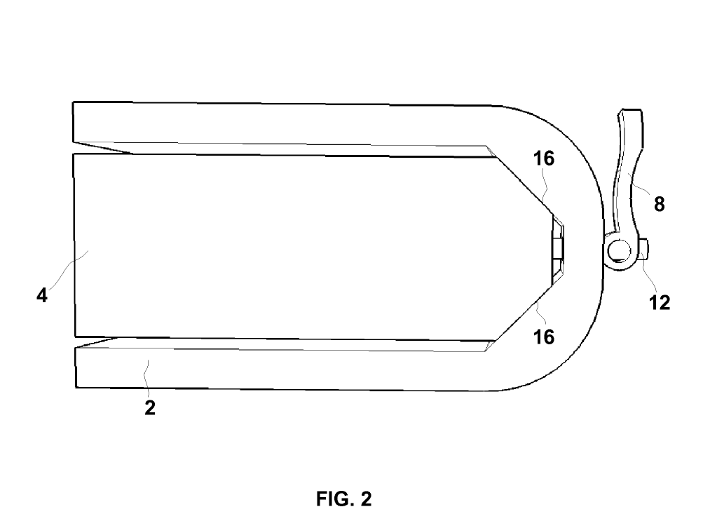

Turning now to FIG. 2, one end of delay-line 4 comprises opposing vertical contact surfaces 16 at an angle, preferably at 45 degrees. Probe holder 2 has opposing vertical surfaces that match opposing vertical contact surfaces 16. Locking latch 8 forces angled contact surfaces 16 of delay-line 4 into contact with matching surfaces on probe holder 2 such that exactly the same coupling positioning between delay-line 4 and test surface 15 of the test object is readily achieved in-between inspection sessions in a tool-free manner.

It is apparent that the size of probe 4 and probe holder 2 are so designed that probe 4 can be moved in and out of holder 2. There is, therefore, a small gap on both sides of the probe as well as at the latching position between the delay-line 4 and holder 2. The gaps herein described leave undesirable wiggling space between probe 4 and probe holder 2.

Continuing with FIG. 2, presenting a solution to the above problem, another novel aspect of the present disclosure is the use of a pair of angled contact surfaces 16 on delay-line 4 and a pair of matching angled contact surfaces on probe holder 2. These matching contact surfaces provide two reference planes along surface 16 such that latch 8 forces both reference planes into intimate contact such that no additional movement is possible between delay-line 4 and probe holder 2. This mechanism ensures that, when at the locked latch position, exactly the same coupling positioning between delay-line 4 and test surface 15 of the test object is readily achieved in-between inspection sessions in a tool-free manner. This also makes any wiggling or tilting of delay-line 4 with respect to holder 2 impossible in both the passive (the orientation parallel to the individual transducer element length or probe width) and active (the orientation parallel to the phased array probe axis consisting of multiple elements) phased array directions.

This novel design ensures the acoustic energy impinges perpendicularly onto test surface 15. In this embodiment, both angled surfaces 16 are advantageously designed at 45 degrees with respect to the long axis of the wedge (both the surfaces are separated by 90 degrees) which provides optimal tilt or skew restriction in all directions.

It should be noted that the above design is suitable for all embodiments herein disclosed.

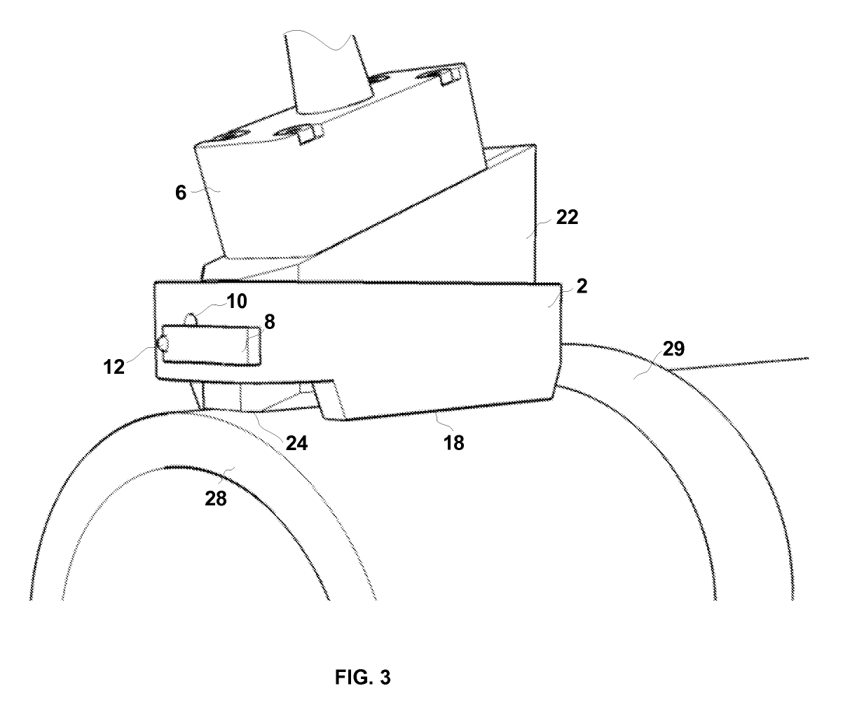

Reference is now turned to FIG. 3, an angle beam wedge 22 is shown to be held by the novel probe holder 2 for inspection of weld 29 on a pipe test object 28. Probe 6 is affixed to angled delay-line 22. Delay-line 22 is made of typical ultrasonic wedge material such as Rexolite®. The same as in FIG. 1, when latch 8 is at its open position, the respective positions of wear footing 18 and coupling surface 24 are vertically freely adjustable, thereby allowing for locating a relative position so that coupling surface 24 is in intimate contact with test object 28. Once such fitting is established, latch 8 is then switched to the locked position, at which coupling surface 24 maintains intimate acoustic coupling with test object 29 to facilitate the angle beam inspection while wear footing 18 provides appropriate stability of holder 2. As can be seen, the novel design allows delay-line 4 and holder wear footing 18 to fit naturally and snugly onto surface 15. The probe holder is hence ready to be glided over the surface of the test objects, with the delay-line having a snug fit with the surface of the test object.

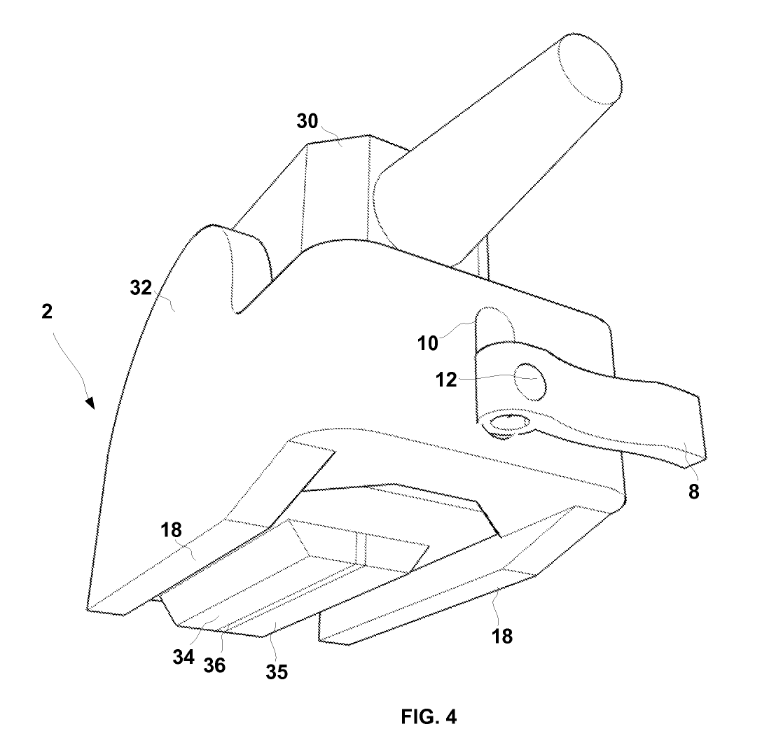

Referring now to FIG. 4, a slightly varied form of the preferred embodiment fashions ‘ear-shaped’ side walls 32 allowing inspectors to conveniently hold probe holder 2. Also in this slightly altered embodiment, holder 2 is configured to hold a dual phased array probe 30 which comprises two parallel rows of phased array elements (not shown). Each row of elements is associated with a delay-line 34 or 35, separated by an acoustic barrier 36. Similar to FIG. 1, when latch 8 is at its open position, the respective positions of wear footing 18 and coupling surfaces 34 and 35 are vertically freely adjustable, thereby allowing for locating a relative position so that coupling surfaces 34 and 35 are in intimate contact with the test object. Once such fitting is established, latch 8 is then switched to the locked position, at which coupling surfaces 34 and 35 maintain an intimate acoustic coupling to the test object while wear footing 18 provides appropriate stability of holder 2. As can be seen, the novel design allows delay-line 4 and holder wear footing 18 to fit naturally and snugly onto the test surface. The probe holder 2 is hence ready to be glided over the surface of the test objects, with the delay-line having a snug fit with the surface of the test object. Again the novel design enables inspection on a large range of geometric test object diameters.

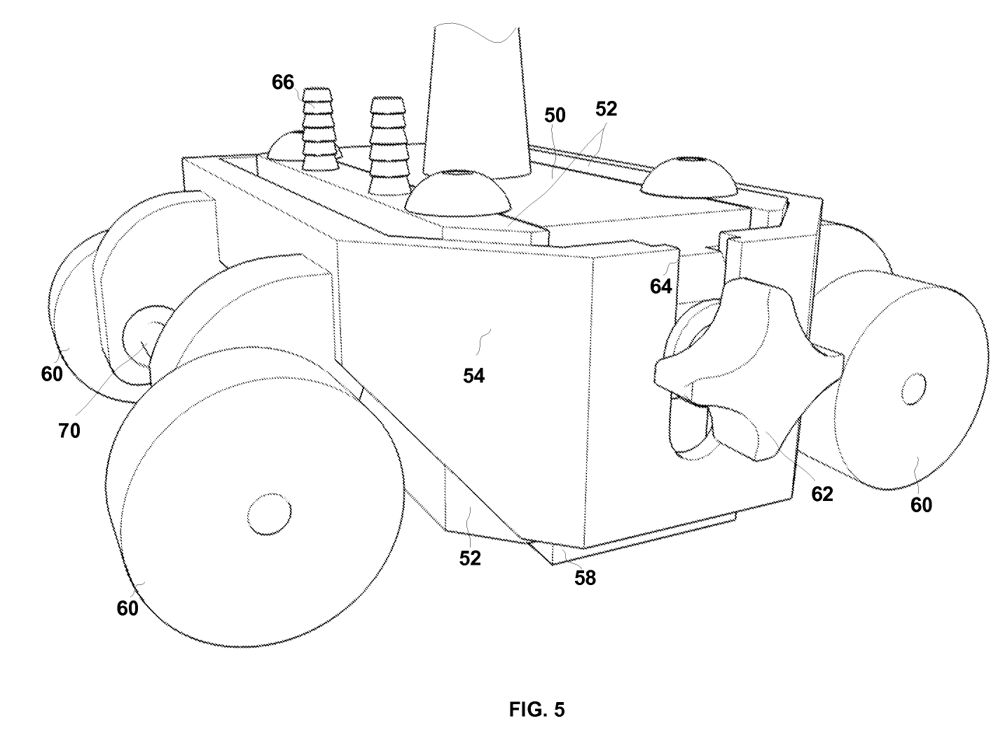

Referring now to FIG. 5, an alternative embodiment of the herein disclosed probe holder is illustrated and referred to as “wheelable embodiment”. As can be seen, probe holder 54 features a set of wheels 60 as its footing. A water wedge 52 is housed or carried by holder 54 and probe 50 is situated within water wedge 52.

Water wedge 52 comprises its housing, irrigation barbs 66 and a water column (not shown) used for acoustic coupling. Water wedge 52 also includes a malleable gasket 58 which conforms to various diameters of said test object (not shown) and provides intimate contact between the test object and the water wedge 52.

It should be noted that water wedge 52 is built using known, conventional methods, being customized to fit into the novel probe holder. In other words, the presently disclosed probe holder 54 can be used to carry a wide range of water wedges, being slightly customized to fit into holder 54.

A slightly varied locking mechanism featuring a knob 62 and its matching bolt (not shown) is used in this alternative embodiment, replacing the latch in the preferred embodiment.

Similar to the preferred embodiment, water wedge 52 is vertically slidable within probe holder 54 via slot 64 and can be locked into a given vertical position via knob 62. Sharing further similarity with previously disclosed embodiments, water wedge 52 and probe holder 54 comprise matching opposing angled surfaces that are brought into intimate contact by tightening knob 62 to restrict tilting and screwing of wedge 52.

Probe holder 54 comprises axles 70 and wheels 60 which are brought into contact with the test object during an inspection. The adjustability of water wedge 52 and probe holder 54 in the vertical direction allows inspecting test objects with a large range of diameters, without changing the water wedge, while maintaining efficient coupling, stable contact and repeatable and appropriate alignment of the probe with the surfaces of test objects.

Referring to all embodiments, solid delay-line surfaces 14, 24, 34 and 35 are advantageously as small as possible in the passive phased array direction, while maintaining appropriate acoustic dimensions, in order to provide a contact area as small as possible, thereby providing appropriate coupling on the smallest possible surface curvature. The width of the delay-line surfaces depends principally but not exclusively on the delay-line material, the height of the delay-line and the size and frequency of the probe elements. The range of delay-line surface curvatures compatible with a given adjustable wedge depends on certain factors such as the size of delay-line surface 14 (or 24 or 34 and 35), the distance between wear footings (18 in preferred embodiment and 60 in the wheelable embodiment) and the length of slot 10.

The above descriptions and drawings disclose illustrative embodiments of the invention. Given the benefit of this disclosure, those skilled in the art should appreciate that various modifications, alternate constructions, and equivalents may also be employed to achieve the advantages of the invention.

For example, other configurations or other types of wedges such as water boxes, angle beam water wedges and rubber wedges can be used. In fact, any delay-line material may be used within the scope of the present invention.

It is very important to mention that the adjustability of the above mentioned wedges/probes is not limited to inspecting convex surfaces such as the exterior surface of pipes. The embodiments described herein can also be employed for inspecting concave surfaces such as the inside of pipes or tanks.

The locking mechanism embodied by the present invention is also not limited to the use of latches or knobs. For example, a single or a pair of spring loaded buttons can be devised so that pressing the buttons would allow the probe to move freely in vertical direction inside the probe holder to allow proper fitting of the coupling surface with the test object. Releasing the buttons would allow the spring(s) to exert pressure on the probe and to thereby firmly hold the probe during inspection sessions.

Nor is the invention limited to using opposing angled contact surfaces that provide two reference planes separated by 90 degrees. As such, almost any two opposing angled surfaces can be used and remain within the scope of the present invention. The invention is not limited to using the bar wear surfaces shown in the embodiments as disclosed. Other contact/confining methods such as three or four or any other number of contact points may be used.

For example, other confining and guiding mechanisms can include corresponding vertical tracks disposed on the probe's external surface and the probe holder's internal surface. The tracks can be configured to restrict probe's relative movement inside the probe holder in all directions, except allowing adjustment vertically.

It should be further noted that delay-lines described in the present disclosure can be of many forms or types of wedges, wear plates and integral wear plates, etc.

Further, the wheeling embodiment is not limited with respect to the type of wheels as shown. Any rolling mechanism, notably plastic and magnetic wheels can be used.

Although the embodiments described herein refer to repeatable and appropriate positioning of the passive direction of the phased array probe parallel to the surface of the test object such that the acoustic beam impinges perpendicularly onto the surface of the test object, the invention is not limited thereto. It is conceivable to employ the invention to a wedge for which the appropriate position of the probe with respect the surface of the test object comprises a skew angle in the passive phased array direction.

Although acoustic probe and wedge have been described in relation to particular exemplary embodiments, the probe holder according to the present disclosure can also be applied to other NDT/NDI probes. For example, eddy current probes, eddy current array probes, EMAT probes and bond testing probes. Advantageously, this invention can be employed to provide adjustable and constant lift-off for eddy current, eddy current array or EMAT probes.

Although the present invention has been described in relation to particular exemplary embodiments thereof, many other variations and modifications and other uses will become apparent to those skilled in the art. It is preferred, therefore, that the present invention not be limited by the specific disclosure.

What is claimed is:

1. A probe assembly for non-destructive testing of a target surface of a test object, the probe assembly comprising:
a non-destructive testing probe having a test surface facing the target surface of the test object;
a footing member configured as a probe holder, slidable over the target surface and including a guiding member;
a locking member having a locked position and an unlocked position and being mechanically coupled to the probe via the guiding member; and
the testing probe and its test surface being freely adjustable to a high or low position relative to the footing member when the locking member is in the unlocked position to obtain a position wherein the probe is affixed to the probe holder when the locking member is in the locked position and the test surface of the probe being maintained and coupled with the target surface when the probe holder is slid over the target surface.

2. The probe assembly of claim 1, wherein the guiding member extending generally perpendicularly to the test surface.

3. The probe assembly of claim 1, wherein the guiding member is a slot configured on a vertical portion of the probe holder.

4. The probe assembly of claim 3, wherein the locking member is configured as a tightenable knob which is coupled to the probe via the guiding slot.

5. The probe assembly of claim 3, wherein the locking member is configured as a pivotable lever.

6. The probe assembly of claim 3, wherein the locking member comprises a bolt and a matching nut.

7. The probe assembly of claim 3, wherein the locking member comprises a two-position latch.

8. The probe assembly of claim 1, wherein the guiding member including a set of matching tracks installed correspondingly on the probe and on the probe holder, wherein the tracks confine the relative movement between the probe and the probe holder in all directions other than allowing vertical adjustment of the relative position of probe and probe holder.

9. The probe assembly of claim 1, wherein the locking member including at least one spring loaded actuator.

10. The probe assembly of claim 1, further comprising a sensor and a delay-line.

11. The probe assembly of claim 10, wherein the delay-line is a 0-degree wedge.

12. The probe assembly of claim 10, wherein the delay-line is an angle-beam wedge.

13. The probe assembly of claim 10, wherein the delay-line is water column delay-line with a water retaining membrane.

14. The probe assembly of claim 10, wherein the delay-line is a water column delay-line.

15. The probe assembly of claim 10, wherein the delay-line is a rubber delay-line.

16. The probe assembly of claim 10, wherein the delay-line is integrated into the sensor.

17. The probe assembly of claim 1, wherein the probe holder is shaped such that it forms two or more confining surfaces, at least the two confining surfaces providing two reference planes separated by an angle of more than 0 degrees and less than 180 degrees, and wherein the probe is correspondingly shaped.

18. The probe assembly of claim 17, wherein the angle between the two reference planes is approximately an angle of 90 degrees.

19. The probe assembly of claim 1, wherein the probe holder has a rectangular parallelepiped shaped and the probe is correspondingly shaped.

20. The probe assembly of claim 1, wherein the probe holder has a cylinder shape and the probe is correspondingly shaped.

21. The probe assembly of claim 1, wherein the footing member contains a plurality of stands which extend from the probe holder.

22. The probe assembly of claim 1, wherein the footing member comprises a periphery edge extending from the probe holder.

23. The probe holder of claim 1, wherein the footing member includes a plurality of wheeling elements attached to the probe holder.
